(19) United States
(12) Patent Application Publication
(10) Pub. No.: US 2018/0160851 A1
(43) Pub. Date: Jun. 14, 2018

(54) Stirring fryer

(71) Applicant: Hang JIANG, Hong Kong (HK)

(72) Inventor: Hang JIANG, Hong Kong (HK)

(21) Appl. No.: 15/377,919

(22) Filed: Dec. 13, 2016

(51) Int. Cl. A47J 37/10

(52) U.S. Cl. CPC A47J 37/101; A47J 37/108; A47J 37/10

(57) ABSTRACT

A stirring fryer contains: a base, a frying holder, at least two heating devices, a motor, at least one stirrer, a drive shaft, and a gas collector. The frying holder includes topmost and bottommost bodies. The bottommost body has a fixing groove and a connection trench, and two orifices are defined on the bottommost and topmost bodies, respectively. The topmost body has a ratchet mechanism and is coupled with the lid, and the bottommost body is connected with the base. The at least two heating devices are arranged on the topmost and bottommost bodies, and the lid has an exhaust vent communicating with the gas collector. The drive shaft is accommodated in two orifices and is coupled with the motor. Each stirrer is connected with the drive shaft and has multiple rotatable blades, and each of the multiple rotatable blades has a through hole defined thereon.

### FIELD OF THE INVENTION

The present invention relates to a stirring fryer which stirs and fries a variety of ingredients simultaneously.

### BACKGROUND OF THE INVENTION

A conventional fryer cannot only fry one of various ingredients, so the variously ingredients cannot be fried by the fryer simultaneously, thus have long frying time. In addition, the fryer cannot recycle gases during frying the various ingredients.

The present invention has arisen to mitigate and/or obviate the afore-described disadvantages.

### SUMMARY OF THE INVENTION

The primary objective of the present invention is to provide a stirring fryer which stirs and fries a variety of ingredients simultaneously.

Another objective of the present invention is to provide a stirring fryer which is simplified and is capable of recycling gases as frying the variety of ingredients.

To obtain above-mentioned objectives, a stirring fryer provided by the present invention contains: a base, a frying holder, at least two heating devices, a motor, at least one stirrer, a drive shaft, and a gas collector.

The frying holder, the motor, and the gas collector are arranged on the base.

The frying holder includes a bottommost body, a topmost body, and a lid. The bottommost body has a fixing groove defined on a bottom thereof and has a connection trench formed on a top thereof, and an orifice is defined on a central position of each of the bottommost and topmost bodies. The topmost and bottommost bodies are connected via the fixing groove and the connection trench of the bottommost body, and two orifices of the bottommost and topmost bodies are coaxial. The topmost body has a ratchet mechanism arranged on a side surface of a top thereof and is coupled with the lid via the ratchet mechanism, and the bottommost body is in connection with the base.

The at least two heating devices are arranged on bottoms of the topmost and bottommost bodies, and the lid of the frying holder has an exhaust vent communicating with the gas collector.

The drive shaft is fixed and rotates in the frying holder via the two orifices of the bottommost and topmost bodies, and a distal end of the drive shaft is coupled with the motor.

Each of the at least one stirrer is mounted in each of the topmost and bottommost bodies of the frying holder and is in connection with the drive shaft, and wherein each stirrer has multiple rotatable blades, and each of the multiple rotatable blades has a through hole defined thereon.

### BRIEF DESCRIPTION OF THE DRAWINGS

FIG. 1 is a cross sectional view showing the assembly of a stirring fryer according to a preferred embodiment of the present invention.

### DETAILED DESCRIPTION OF THE PREFERRED EMBODIMENTS

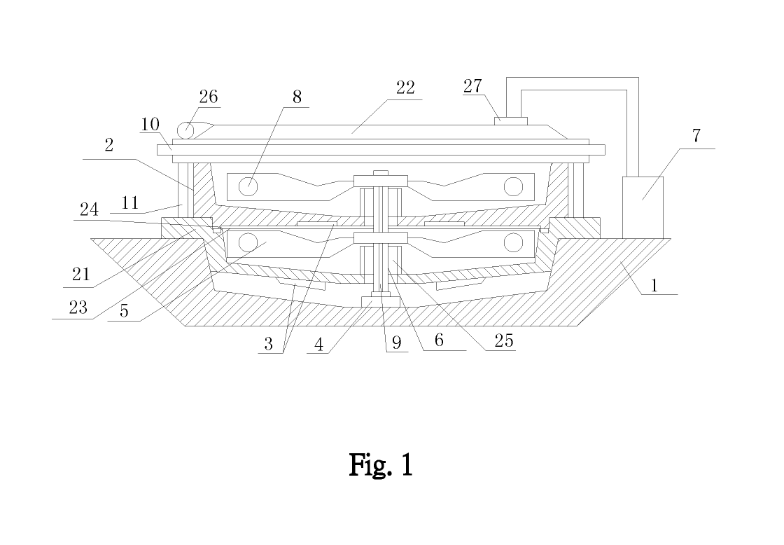

With reference to FIG. 1, a stirring fryer according to a preferred embodiment of the present invention comprises: a base 1, a frying holder 2, at least two heating devices 3, a motor 4, at least one stirrer 5, a drive shaft 6, and a gas collector 7.

The frying holder 2, the motor 4, and the gas collector 7 are arranged on the base 1, wherein the frying holder 2 includes at least two bodies 21 and a lid 22. In this embodiment, two bodies 21 (i.e., a topmost and a bottom body 1) are provided, wherein the bottommost body 21 has a fixing groove 23 defined on a bottom thereof and has a connection trench 24 formed on a top thereof, and an orifice 25 defined on a central position of each of the bottommost and topmost bodies 21, wherein the topmost and bottommost bodies 21 are connected via the fixing groove 23 and the connection trench 24 of the bottommost body 21, and two orifices 25 of the bottommost and topmost bodies 21 are coaxial. The topmost body 21 has a ratchet mechanism 26 arranged on a side surface of a top thereof and is coupled with the lid 22 via the ratchet mechanism 26, and the bottommost body 21 is in connection with the base 1.

The at least two heating devices 3 are arranged on bottoms of the topmost and bottommost bodies 21, and the lid 22 of the frying holder 2 has an exhaust vent 27 communicating with the gas collector 7.

The drive shaft 6 is fixed and rotates in the frying holder 2 via the two orifices 25 of the bottommost and topmost bodies 21, and a distal end of the drive shaft 6 is coupled with the motor 4.

Each of the at least one stirrer 5 is mounted in each of the topmost and bottommost bodies 21 of the frying holder 2 and is in connection with the drive shaft 6, wherein each stirrer 5 has multiple rotatable blades, and each of the multiple rotatable blades has a through hole 8 defined thereon.

Furthermore, at least one air channel 9 is arranged on an outer wall of the drive shaft 6.

Preferably, at least on closing strap is arranged on a connection area of the topmost body 21 and the lid 22 and on a connection area of the fixing groove 23 and the connection trench 24 of the bottommost body 21.

The topmost and bottommost bodies 21 are connected together by way of at least two springs 11.

Accordingly, the stirring fryer of the present invention stirs and fries a variety of ingredients simultaneously. Preferably, the stirring fryer is simplified and is capable of recycling gases as frying the variety of ingredients.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A stirring fryer comprising: a base, a frying holder, at least two heating devices, a motor, at least one stirrer, a drive shaft, and a gas collector;
wherein the frying holder, the motor, and the gas collector are arranged on the base;
wherein the frying holder includes a bottommost body, a topmost body, and a lid; the bottommost body has a fixing groove defined on a bottom thereof and has a connection trench formed on a top thereof, and an orifice is defined on a central position of each of the bottommost and topmost bodies, wherein the topmost and bottommost bodies are connected via the fixing groove and the connection trench of the bottommost body, and two orifices of the bottommost and topmost bodies are coaxial; the topmost body has a ratchet mechanism arranged on a side surface of a top thereof and is coupled with the lid via the ratchet mechanism, and the bottommost body is in connection with the base;
wherein the at least two heating devices are arranged on bottoms of the topmost and bottommost bodies, and the lid of the frying holder has an exhaust vent communicating with the gas collector;
wherein the drive shaft is fixed and rotates in the frying holder via the two orifices of the bottommost and topmost bodies, and a distal end of the drive shaft is coupled with the motor; and
wherein each of the at least one stirrer is mounted in each of the topmost and bottommost bodies of the frying holder and is in connection with the drive shaft, and wherein each stirrer has multiple rotatable blades, and each of the multiple rotatable blades has a through hole defined thereon.

2. The stirring fryer as claimed in claim 1, wherein at least one air channel is arranged on an outer wall of the drive shaft.

3. The stirring fryer as claimed in claim 1, wherein at least on closing strap is arranged on a connection area of the topmost body and the lid and on a connection area of the fixing groove and the connection trench of the bottommost body.

4. The stirring fryer as claimed in claim 1, wherein the topmost and bottommost bodies are connected together by way of at least two springs.
